(19) United States
(12) Patent Application Publication
(10) Pub. No.: US 2010/0323719 A1
(43) Pub. Date: Dec. 23, 2010

(54) Method of Enhancing Positioning Measurement and Related Communication Device

(76) Inventor: Yu-Chih Jen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/820,153

(22) Filed: Jun. 22, 2010

Related U.S. Application Data
(60) Provisional application No. 61/218,988, filed on Jun. 22, 2009.

(51) Int. Cl. H04W 64/00

(52) U.S. Cl. 455/456.1

(57) ABSTRACT

A method of enhancing positioning measurement for a mobile device in a wireless communications system is disclosed. The method comprises initiating a positioning measurement automatically or when a service of the mobile device is triggered or initiated.

### CROSS REFERENCE TO RELATED APPLICATIONS

This application claims the benefit of U.S. Provisional Application No. 61/218,988, filed on Jun. 22, 2009 and entitled “Method and Apparatus for enhancement of positioning measurement” the contents of which are incorporated herein in their entirety.

### BACKGROUND OF THE INVENTION

1. Field of the Invention

A method utilized in a wireless communication and related communication device are disclosed, and more particularly, to a method of enhancing positioning measurement in a wireless communications system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs). The UE of the LTE system can transmit and receive data on only one carrier component at any time.

Toward advanced high-speed wireless communications system, such as transmitting data in a higher peak data rate, LTE-Advanced system is standardized by the 3rd Generation Partnership Project (3GPP) as an enhancement of LTE system. LTE-Advanced system targets faster switching between power states, improves performance at the cell edge, and includes subjects, such as bandwidth extension, coordinated multipoint transmission/reception (COMP), uplink multiple input multiple output (MIMO), etc. The UE of the LTE-Advanced system can use a carrier aggregation function to simultaneously transmit and receive data on multiple carrier components.

COMP is considered for LTE-Advanced as a tool to improve coverage of high data rates, cell edge throughput, and system efficiency, which implies dynamic coordination among multiple geographical separated points. That is, when an UE is in a cell-edge region, the UE is able to receive signal from multiple cells, and the multiple cells can receive transmission of the UE.

For certain reason, such as emergency consideration, several positioning methods are developed for UE positioning estimation. Positioning methods supported within the E-UTRAN include cell identity (ID) based method, observed time difference of arrival (OTDOA) method, network-assisted Global Navigation Satellite System (GNSS) method, etc. Please note that, the OTDOA positioning method may be assisted by network configurable idle periods (namely OTDOA-IPDL), in order to potentially improve the hearability of neighbouring eNBs. The OTDOA positioning method involves measurements made by a UE, and the measurement results are then sent to the network (e.g. E-UTRAN) for UE positioning calculation.

In the LTE-Advanced system, the network requests the UE to perform a positioning measurement, and configures a positioning configuration (e.g. a positioning subframe) to the UE for the positioning measurement. The positioning subframe is based on a normal subframe with no data or a Multimedia Broadcast multicast service Single Frequency Network (MBSFN) subframe with no data. Therefore, the UE performs positioning measurement during the positioning subframe, and generates a measurement report to the network. Thus, the network performs the UE positioning estimation based on the measurement report.

In an emergency, the UE shall be located as soon as possible. However, in the prior art, the positioning measurement of the UE is triggered only by the network. In other words, the UE has to wait for a request from the network, and then can perform the positioning measurement. Since the UE cannot perform the positioning measurement until the network requests the UE to do so, UE positioning delay occurs. In the emergency, positioning delay may endanger one's life.

Moreover, several scenarios should be taken into consideration, and are described as follows.

In the first scenario, according to the LTE-Advanced system, the network includes features of the COMP, which provides requirements (e.g. coordination and synchronization) for the positioning measurement. However, the LTE-Advance system does not specify how the UE performs the positioning measurement in the COMP operation. Moreover, the configuration of the positioning measurement and mode of operation are never concerned. The functionalities of the coordination and synchronization are well-known in the art, so it is not given herein.

In the second scenario, during the positioning measurement, the UE measures the positioning signals (e.g. reference signals) from cells associated with the positioning measurement at downlink in the positioning subframe, thereby generating the downlink measurement result to the network. After that, the network performs UE positioning estimation based on the downlink measurement result. However, the positioning signals may arrive at the UE at different delays due to multi-path propagation or capability of the UE. That is, the downlink measurement result may not be accurate. Hence the UE positioning estimated by the network is inaccurate, impacting positioning performance.

In the third scenario, the UE may perform different measurements, such as a mobility measurement, a positioning measurement, and signal quality measurement, etc. However, the LTE-Advanced system does not clearly specify priorities of transmitting measurement reports corresponding to the abovementioned measurements as well as priorities of transmitting positioning measurement report and uplink data. In this situation, a transmission of a positioning measurement report may be postponed, thereby causing positioning delay.

### SUMMARY OF THE INVENTION

A method of enhancing positioning measurement in a wireless communications system is disclosed to solve the abovementioned problems.

A method of enhancing positioning measurement for a mobile device in a wireless communications system is disclosed. The method comprises initiating a positioning measurement automatically or when a service of the mobile device is triggered or initiated.

A method of enhancing positioning measurement for a network in a wireless communications system is disclosed. The method comprises generating positioning configuration for configuring at least one of a plurality of cells in the wireless communications system.

A method of enhancing positioning measurement for a network in a wireless communications system is disclosed. The method comprises sending a message to configure a coordinated multipoint transmission/reception (COMP) operation to a mobile device of the wireless communications system, wherein the message comprises at least one of positioning measurement information and positioning measurement activation indication.

A method of enhancing positioning measurement for a mobile device in a wireless communications system is disclosed. The method comprises receiving a message for configuring a coordinated multipoint transmission/reception (COMP) operation, from a network of the wireless communications system, wherein the message includes at least one of positioning measurement information and a positioning measurement activation indication, and performing a positioning measurement according to at least one of positioning measurement information and the positioning measurement activation indication.

A method of enhancing positioning measurement for a network in a wireless communications system is disclosed. The method comprises assigning a preamble to a mobile device of the wireless communications system for initiation of a random access procedure of the mobile device, and obtaining uplink reception timing information from at least a cell that receives from the mobile device the preamble, wherein the uplink reception timing information comprise timing of reception of the preamble assigned by the network.

A method of enhancing positioning measurement for a mobile device in a wireless communications system is disclosed. The method comprises performing at least a random access procedure each corresponding to at least one of a plurality of cells to acquire uplink timing advanced information from the plurality of cells, and sending a report including the uplink timing advanced information to a network of the wireless communications system.

A method of enhancing positioning measurement for a mobile device in a wireless communications system is disclosed. The method comprises determining or considering that a first type report associated with a positioning measurement has higher priority than a second type report which is not associated with the positioning measurement.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 illustrates a schematic diagram of an exemplary wireless communications system.

FIG. 2 illustrates a schematic diagram of an exemplary communication device.

FIG. 3 illustrates a schematic diagram of exemplary program code.

FIG. 4-10 are flowcharts of exemplary processes according to the present disclosure.

### DETAILED DESCRIPTION

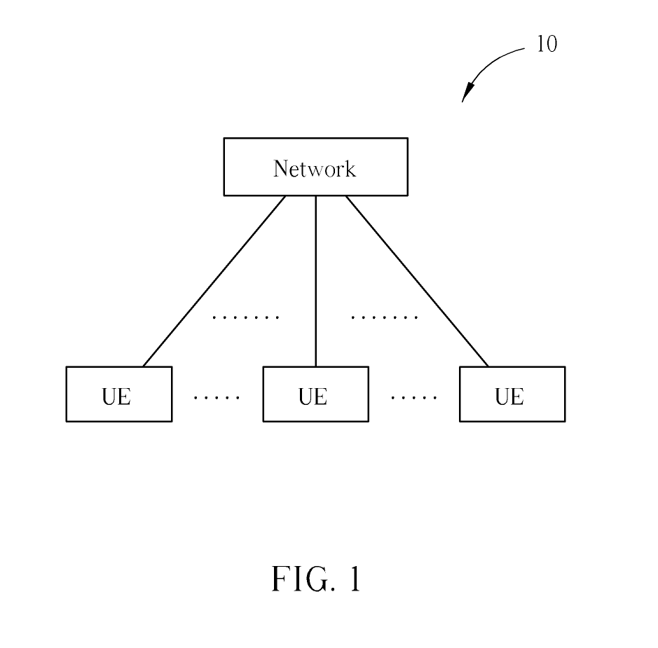

Please refer to FIG. 1, which illustrates a schematic diagram of a wireless communications system 10 according to an example. Briefly, the wireless communications system 10 is composed of a network and a plurality of mobile devices. The wireless communications system 10 may be a LTE (long-term evolution) Advanced system featuring coordinated multipoint transmission/reception (COMP). In the LTE-Advanced system, the network can be referred as a EUTRAN (evolved-UTRAN) comprising a plurality of eNBs or a core network entity (e.g. Mobility Management Entity called MME), whereas the mobile devices are referred as to user equipments (UEs). According to the LTE-Advanced system, the UE can operate with COMP, and can be devices such as mobile phones, computer systems, etc. This terminology will be used throughout the application for ease of reference. However, this should not be construed as limiting the disclosure to any one particular type of network. In some examples, the network and the UE may be seen as a transmitter or receiver according to transmission direction, e.g., for uplink (UL), the UE is the transmitter and the network is the receiver, and for downlink (DL), the network is the transmitter and the UE is the receiver.

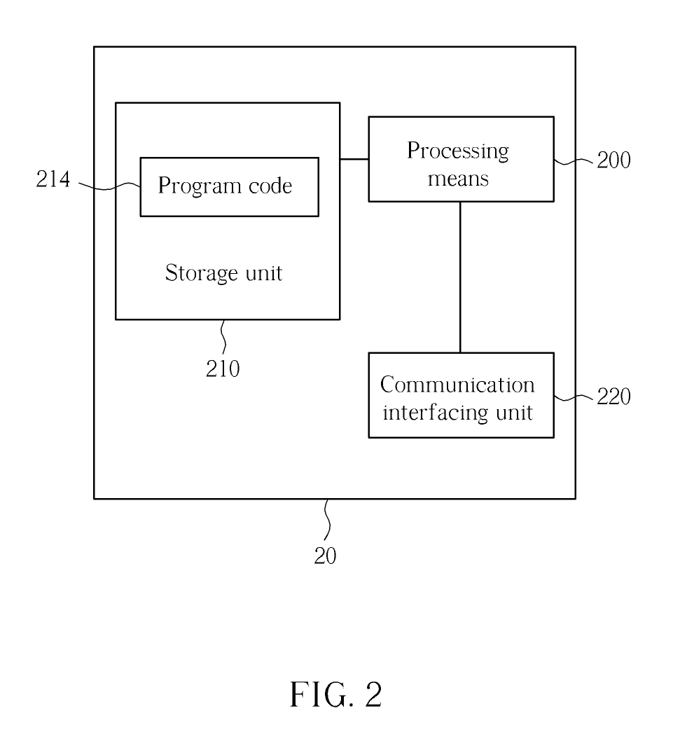

FIG. 2 illustrates a schematic diagram of an exemplary communication device 20. The communication device 20 can be the mobile device or the network shown in FIG. 1. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), random-access memory (RAM), CD-ROMs, magnetic tapes, hard disks, and optical data storage devices. The communication interfacing unit 220 is preferably a radio transceiver and can exchange wireless signals with the network according to processing results of the processing means 200.

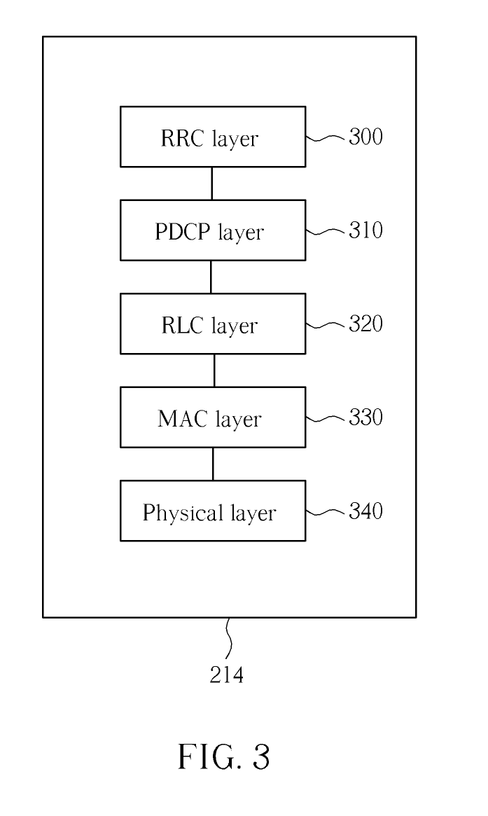

Please refer to FIG. 3, which illustrates a schematic diagram of the program code 214 for the LTE-Advanced system according to an example. The program code 214 includes program code of multiple communications protocol layers, which from top to bottom are a radio resource control (RRC) layer 300, a packet data convergence protocol (PDCP) layer 310, a radio link control (RLC) layer 320, a medium access control (MAC) layer 330 and a physical (PHY) layer 340. When the communication device 20 is referred as to the mobile device shown in FIG. 1, the RRC layer 300 of the communication device 20 obtains measurement results from the MAC layer 330 and the physical layer 340, and generates a measurement report based on the measurement results. Then, the measurement report is sent to the network. On the other hand, when the communication device 20 is referred as to the network shown in FIG. 1, the RRC layer 300 of the network may provide the mobile device with required information associated with positioning measurement.

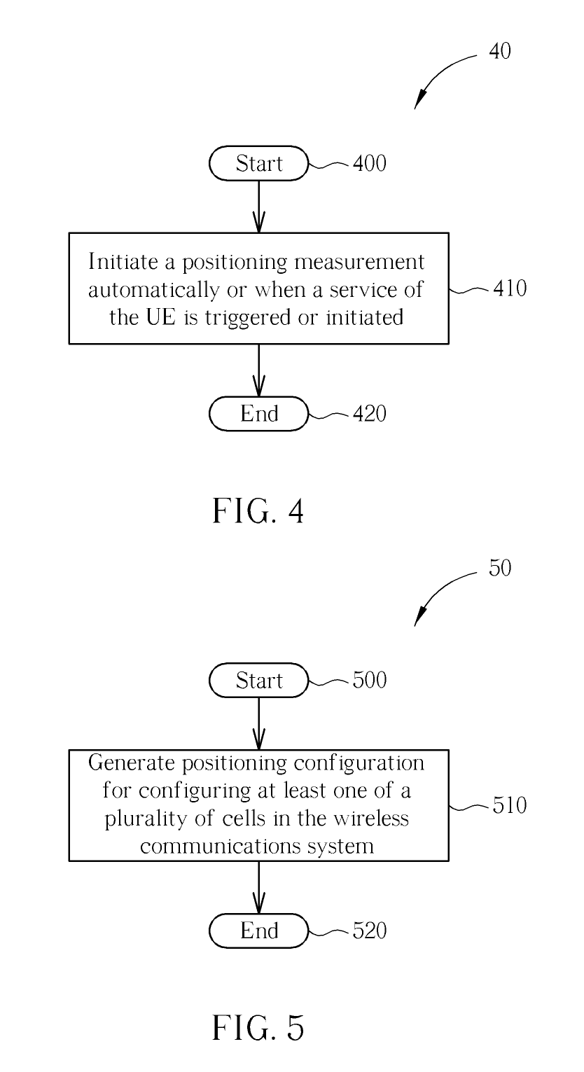

Please refer to FIG. 4, which illustrates a flowchart of an exemplary process 40. The process 40 is utilized in a UE as the communication device 20 of FIG. 2 for enhancing position measurement. The process 40 may be compiled into the program code 214 and includes the following steps:

Step 400: Start.

Step 410: Initiate a positioning measurement automatically or when a service of the UE is triggered or initiated.

Step 420: End.

According to the process 40, the UE initiates the positioning measurement automatically or when a certain service (e.g. an emergency service, or a service where the UE autonomously does positioning or does positioning with another UE, or a service where the UE obtains positioning measurement request) is triggered or initiated. Please note that, the service may be a protocol procedure, a function, an application or a behavior. In other words, the UE has no need to wait for the network to configure the positioning measurement. Since the UE can initiate the positioning measurement without network request, the positioning delay is avoided.

Please note that, the service may be triggered or initiated when the UE is in a radio resource control (RRC) idle state or in a RRC connected state, and thereby the positioning measurement is initiated during the RRC idle state or the RRC connected state. When the service is triggered or initiated in the RRC idle state, the UE may perform a random access procedure for transmitting a positioning measurement report to the network, and moves from the RRC idle state to the RRC connected state. On the other hand, when the service is triggered or initiated in the RRC connected state, the UE may perform a random access procedure for transmitting a positioning measurement report to the network, and remain in the RRC connected state. Please note that, the random access procedure is further used for at least one of establishing RRC connection, acquiring uplink synchronization, acquiring uplink transmission grant, performing mobility.

Alternatively, the UE may receive an indication, which indicates that the automatic position measurement or initiation of positioning measurement is allowed, from the network, and thereby the UE initiates the positioning measurement automatically. In other words, the network may allow the UE to perform the positioning measurement automatically by the indication, which may be broadcasted via system information or control signaling (e.g. a paging message).

One way for the UE to perform the positioning measurement automatically is described as below. The UE performs a cell selection to find a plurality of cells for the positioning measurement according to a certain rule (e.g. UE previous history, UE capability, or cell selection detection result), and then performs the positioning measurement with the plurality of cells, so as to generate a measurement report. Please note that, the UE shall decide at least three cells for the positioning measurement or the measurement report is available. Then, the UE may perform the random access (RA) procedure (e.g. a contention based RA procedure or a non-contention based RA procedure), and then includes the measurement report in a message 3 of the RA procedure. Thus, the network estimates UE positioning based on the measurement report after receiving the message 3 including the measurement report from the UE. Alternatively, The UE may include the measurement report in a message (e.g. RRC connection setup complete) after the RA procedure is successfully performed, and sends the message to the network.

Instead of the RA procedure, the UE may request an uplink grant for the measurement report transmission. The uplink grant may be obtained based on the following methods. In the first method, when the UE is in the RRC connected state, the UE may request the network for the uplink grant through a dedicated signaling channel (e.g. a scheduling request channel or a positioning report grant channel). In the second method, the UE may request the network for the uplink grant by sending a message (e.g. a RRC message) dedicated for requesting for the uplink grant to the network. In the third method, the UE may initiate a procedure (e.g. the RA procedure) for acquiring available uplink grant from the network. Moreover, a signaling in the dedicated signaling channel, the message, or a signaling during the procedure may comprise an indication indicating a size required for the transmission of the measurement report, so that the network can assign the uplink grant with a proper size to the UE. In addition, the indication may further used for indicating the service related to the positioning measurement.

Please refer to FIG. 5, which illustrates a flowchart of an exemplary process 50. The process 50 is utilized in a network of a wireless communications system for enhancing position measurement. The process 50 may be compiled into the program code 214 and includes the following steps:

Step 500: Start.

Step 510: Generate positioning configuration for configuring at least one of a plurality of cells in the wireless communications system.

Step 520: End.

According to the process 50, the network configures the plurality of cells with the positioning configuration, which comprises information that the UE needs for the positioning measurement, such as information of a positioning subframe, a positioning pattern, a resource allocation, and a positioning signal type. Therefore, when the UE initiates the positioning measurement without any configuration received from the network, the UE can perform the positioning measurement according to the positioning configuration preconfigured to the plurality of cells.

Moreover, the positioning configurations may be broadcasted via system information. Take an example. When the emergency service is triggered, the UE initiates the positioning measurement. Since the UE initiates the positioning measurement autonomously, the network may not provide required information for the positioning measurement. In this situation, the UE performs the cell selection to find suitable cells for the positioning measurement, and reads the system information of the detected cells to obtain the positioning configuration. Therefore, the UE can perform the positioning measurement based on the positioning configuration in the system information of the detected cells.

In addition, take the COMP operation of the LTE-Advanced system into consideration. The COMP operation includes requirements for the positioning measurement (e.g. coordination and synchronization among the cells). The network may configure the cells performing the COMP operation (hereafter called active cells) with positioning configuration. Therefore, the UE with the COMP operation can perform the positioning measurement according to the positioning configuration of the active cells. Alternatively, the positioning configuration may be broadcasted via system information of a donor serving cell whose system information is applicable for all of the active cells and/or included in a COMP activation/configuration signaling from the donor serving cell. Thus, by reading the system information of the donor serving cell of the active cells and/or the COMP activation/configuration signaling from the donor serving cell, the UE can obtain the positioning configuration for doing the positioning measurement in the COMP operation. Please note that, the system information of the donor serving cell and/or the COMP activation/configuration signaling may include complete positioning required information. Alternatively, the system information may include partial positioning required information (e.g. most important information so that the UE takes less time to read from the active cells).

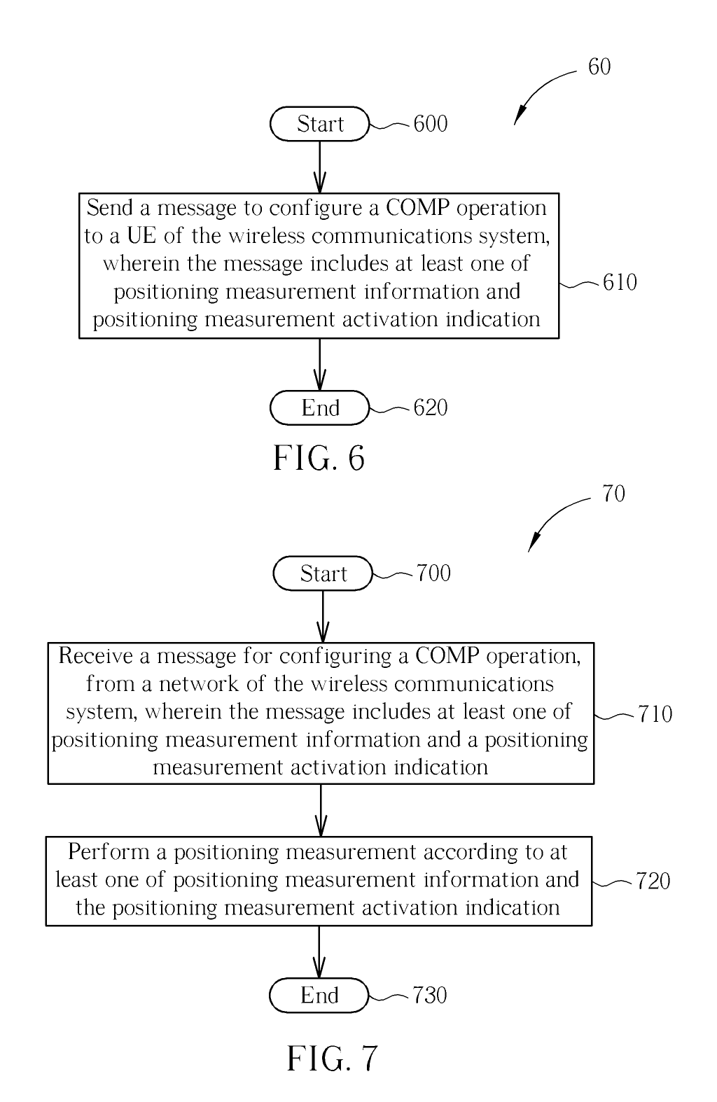

Please refer to FIG. 6, which illustrates a flowchart of an exemplary process 60. The process 60 is utilized in a network of a wireless communications system for enhancing position measurement. The process 60 may be compiled into the program code 214 and includes the following steps:

Step 600: Start.

Step 610: Send a message to configure a COMP operation to a UE of the wireless communications system, wherein the message includes at least one of positioning measurement information and positioning measurement activation indication.

Step 620: End.

According to the process 60, the network configures the COMP operation to the UE through the message, which includes the positioning measurement information. Therefore, when the UE receives the message, the UE activates the COMP operation, and starts to perform the positioning measurement. As abovementioned, the COMP operation provides requirements, such as coordination and synchronization, for the positioning measurement, thereby configuration of the COMP operation may be utilized for initiating the positioning measurement. Thus, by including positioning measurement information into the COMP configuration message, the UE can initiate the positioning measurement during the COMP operation. Moreover, signalling resource can be saved, thereby increasing signaling usage efficiency.

In addition, the message may further include an uplink grant assignment for the measurement report transmission. Please note that, in order to fulfill the requirements of the positioning measurement, the COMP operation shall include at least three cells (e.g. 3 cells controlled by 3 base stations, 2 base stations and a relay, or a base station and 2 relays), so that the UE can collect sufficient measurement results for the network to do the positioning estimation.

Based on the process 60, the UE may take corresponding actions. Please refer to FIG. 7, which illustrates a flowchart of an exemplary process 70. The process 70 is utilized in a UE of a wireless communications system for enhancing position measurement. The process 70 may be compiled into the program code 214 and includes the following steps:

Step 700: Start.

Step 710: Receive a message for configuring a COMP operation, from a network of the wireless communications system, wherein the message includes at least one of positioning measurement information and a positioning measurement activation indication.

Step 720: Perform a positioning measurement according to at least one of positioning measurement information and the positioning measurement activation indication.

Step 730: End.

According to the process 70, the UE is configured with the COMP operation through the message received from the network, where the message includes the positioning measurement information. When the UE receives the message including the positioning measurement information, both of the COMP operation and the positioning measurement of the UE are activated. Therefore, the UE can perform the positioning measurement during the COMP operation without additional information (e.g. the positioning subframe) required from the network since the COMP operation fulfills all the requirements for the positioning measurement.

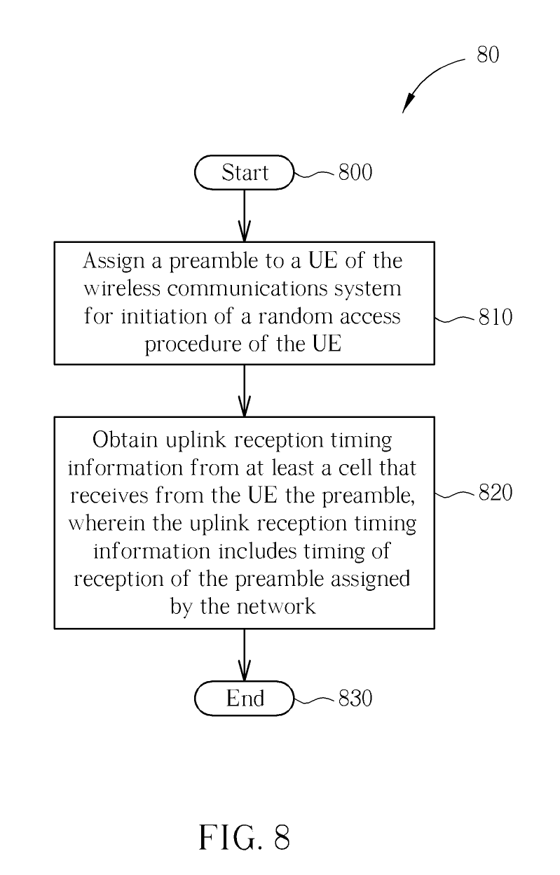

Please refer to FIG. 8, which illustrates a flowchart of an exemplary process 80. The process 80 is utilized in a network of a wireless communications system for enhancing position measurement. The process 80 may be compiled into the program code 214 and includes the following steps:

Step 800: Start.

Step 810: Assign a preamble to a UE of the wireless communications system for initiation of a random access procedure of the UE.

Step 820: Obtain uplink reception timing information from at least a cell that receives from the UE the preamble, wherein the uplink reception timing information includes timing of reception of the preamble assigned by the network.

Step 830: End.

According to the process 80, the network assigns the dedicated preamble (e.g. a non-contention based preamble) to the UE, and thereby the UE initiates the RA procedure with the dedicated preamble. In this situation, the cells that have received the dedicated preamble from the UE send the messages each including the uplink reception timing information to the UE. Thus, the network performs UE positioning estimation not only with the measurement report, but also with the uplink reception timing information, thereby increasing positioning estimation accuracy.

Please note that, the dedicated preamble may be restricted to use a root sequence for scrambling.

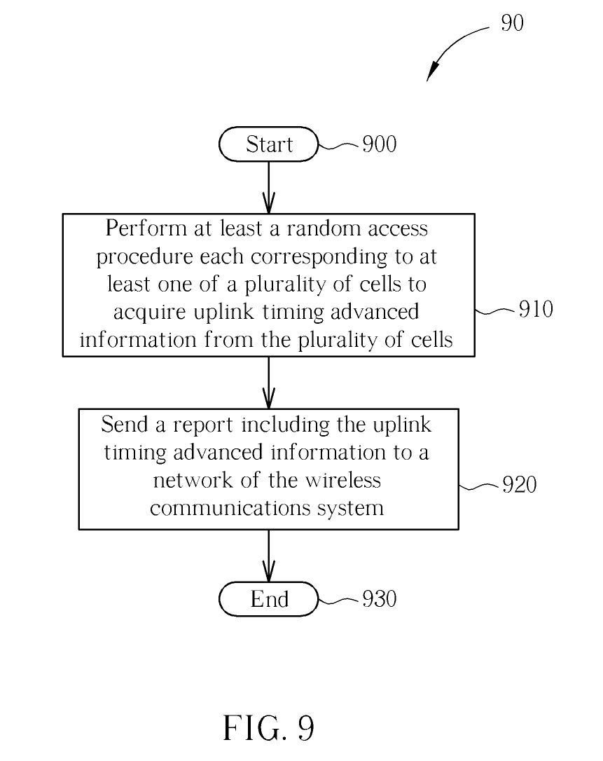

Please refer to FIG. 9, which illustrates a flowchart of an exemplary process 90. The process 90 is utilized in a UE of a wireless communications system for enhancing position measurement. The process 90 may be compiled into the program code 214 and includes the following steps:

Step 900: Start.

Step 910: Perform at least a random access procedure each corresponding to at least one of a plurality of cells to acquire uplink timing advanced information from the plurality of cells.

Step 920: Send a report including the uplink timing advanced information to a network of the wireless communications system.

Step 930: End.

According to the process 90, the UE concurrently performs more than one RA procedure to the plurality of cells, for acquiring uplink timing advanced information of the plurality of cells. The uplink timing advanced information may be included in a message 2 of the RA procedure sent by the network. The UE includes the acquired uplink timing advanced information into the report (e.g. the measurement report or a separate report), and then sends the report to the network. Thus, the network can make use of the acquired uplink timing advanced information for UE positioning estimation, so as to increasing positioning estimation accuracy.

Please note that, a preamble used in the RA procedure can be a random access preamble (e.g. a contention based preamble) or a dedicated preamble.

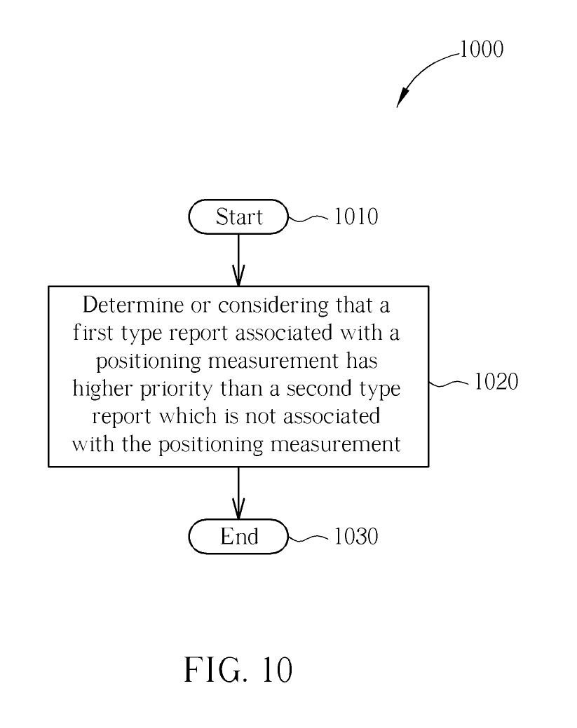

Please refer to FIG. 10, which illustrates a flowchart of an exemplary process 1000. The process 1000 is utilized in a UE of a wireless communications system for enhancing position measurement. The process 1000 may be compiled into the program code 214 and includes the following steps:

Step 1010: Start.

Step 1020: Determine or considering that a first type report associated with a positioning measurement has higher priority than a second type report which is not associated with the positioning measurement.

Step 1030: End.

According to the process 1000, the UE determines that the positioning measurement report has higher priority than other types of measurement report (e.g. a mobility handover measurement report, or a quality measurement report). That is, the positioning measurement report is configured or defined as the highest priority among the measurement reports. Therefore, when receiving an uplink grant from the network, the UE sends the positioning measurement report to the network, and then sends the mobility handover measurement report or the quality measurement report. Briefly, the UE having the positioning measurement report shall first include the positioning measurement report in an uplink transmission if an uplink grant is available, thereby avoiding positioning delay.

Please note that, the uplink grant for the positioning measurement report shall allow transmission of the positioning measurement report carrying positioning measurement result from at least three cells or transmission points (e.g. cells, or relays). Moreover, if the UE cannot measure at least three positioning reference signal arrivals from at least three transmission points upon the expiration of the uplink grant, the UE may not send the positioning measurement report to the network. Alternatively, the UE may send available positioning measurement results (e.g. only two positioning measurement results) to the network.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the exemplary method and means are provided to enhance the positioning measurement. Via preconfigured positioning information, the UE can autonomously perform the positioning measurement, thereby avoiding positioning delay.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of enhancing positioning measurement for a first mobile device in a wireless communications system, the method comprising:
initiating a positioning measurement automatically or when a service of the first mobile device is triggered or initiated.

2. The method of claim 1, wherein the service is an emergency service, or a service where the first mobile device does positioning autonomously or the first mobile device and a second mobile device do positioning to each other, or a service where the first mobile device obtains positioning measurement request.

3. The method of claim 1, wherein initiating the positioning measurement when the service of the first mobile device is triggered or initiated comprises:
initiating the positioning measurement in a radio resource control (RRC) idle state or in a RRC connected state of the first mobile device when the service of the first mobile device is triggered or initiated.

4. The method of claim 3, further comprising:
initiating a random access procedure; and
entering the RRC connected state from the RRC idle state or remaining in the RRC connected state.

5. The method of claim 4, wherein initiating the random access procedure comprises:
initiating the random access procedure for at least one of establishing RRC connection, acquiring uplink synchronization, acquiring uplink transmission grant, performing mobility, and transmitting a positioning measurement report to a network of the wireless communications system.

6. The method of claim 1, wherein initiating the positioning measurement when the service of the first mobile device is triggered or initiated comprises:
receiving an indication for indicating that the automatic positioning measurement or initiation of positioning measurement is allowed, from a network of the wireless communications system; and
initiating the positioning measurement.

7. The method of claim 6, wherein the indication is received from the network via system information or a control signaling.

8. The method of claim 1, further comprising:
performing a cell selection to find a plurality of cells for the positioning measurement or to find at least a cell for a positioning measurement report; and
performing the positioning measurement according to the plurality of cells.

9. The method of claim 8, wherein performing the cell selection to find the plurality of cells for the positioning measurement comprises:
performing the cell selection to find at least three cells for the positioning measurement or for the positioning measurement report.

10. The method of claim 4, further comprising:
generating a first message including a positioning measurement report; and
sending the first message to the network.

11. The method of claim 10, wherein the first message is a message 3 of the random access procedure, or the first message is a message after the intended random access response or contention resolution message of the random access procedure has been received by the first mobile device and the first mobile device has received an uplink transmission grant.

12. The method of claim 1, further comprising:
requesting a network of the wireless communications system for an uplink grant through a dedicated signaling channel when the first mobile device is in a radio resource control (RRC) connected state; or
sending a second message used for requesting for the uplink grant to the network; or
initiating a procedure for acquiring available uplink grant.

13. The method of claim 12, wherein the dedicated signaling channel is a scheduling request channel or a positioning report grant channel.

14. The method of claim 12, wherein the second message, a signaling during the procedure or a signaling on the dedicated signaling channel comprises an indication indicating a size required for transmitting a positioning measurement report or indicating the service related to the positioning measurement.

15. The method of claim 14, further comprising:
sending the positioning measurement report to the network after the uplink grant assigned by the network according to the indication included in the second message or the signaling is received.

16. The method of claim 12, further comprising:
performing the positioning measurement to generate a positioning measurement report; and
sending the positioning measurement report to the network after the uplink grant assigned by the network is received.

17. A method of enhancing positioning measurement for a network in a wireless communications system, the method comprising:
generating positioning configuration for configuring at least one of a plurality of cells in the wireless communications system.

18. The method of claim 17, wherein the positioning configuration is broadcasted via system information of at least one of the plurality of cells.

19. The method of claim 18, wherein the positioning configuration is further included in a coordinated multipoint transmission/reception (COMP) activation/configuration signaling.

20. The method of claim 17, wherein a mobile device of the wireless communications system autonomously initiates a positioning measurement without any configuration that the mobile device receives from the network for the initiation of the positioning measurement.

21. The method of the claim 17, wherein the positioning configuration comprises at least one of information of a positioning subframe, positioning pattern, a resource allocation, and a positioning signal type required for the positioning measurement.

22. A method of enhancing positioning measurement for a network in a wireless communications system, the method comprising:
sending a message to configure a coordinated multipoint transmission/reception (COMP) operation to a mobile device of the wireless communications system, wherein the message comprises at least one of positioning measurement information and a positioning measurement activation indication.

23. The method of the claim 22, wherein the message further comprises an uplink grant assignment for a transmission of a positioning measurement report associated with a positioning measurement performed by the mobile device.

24. The method of the claim 22, wherein the COMP operation comprises at least three cells performing the COMP operation.

25. A method of enhancing positioning measurement for a mobile device in a wireless communications system, the method comprising:
receiving a message for configuring a coordinated multipoint transmission/reception (COMP) operation, from a network of the wireless communications system, wherein the message includes at least one of positioning measurement information and a positioning measurement activation indication; and
performing a positioning measurement according to at least one of positioning measurement information and the positioning measurement activation indication.

26. A method of enhancing positioning measurement for a network in a wireless communications system, the method comprising:
assigning a preamble to a mobile device of the wireless communications system for initiation of a random access procedure of the mobile device; and
obtaining uplink reception timing information from at least a cell that receives from the mobile device the preamble, wherein the uplink reception timing information comprises timing of reception of the preamble assigned by the network.

27. The method of claim 26, wherein the preamble is restricted to used a root sequence for scrambling.

28. The method of claim 26, further comprising:
estimating a position of the mobile device according to the uplink reception timing information and a positioning measurement report associated with a positioning measurement performed by the mobile device.

29. A method of enhancing positioning measurement for a mobile device in a wireless communications system, the method comprising:
performing at least a random access procedure each corresponding to at least one of a plurality of cells to acquire uplink timing advanced information from the at least one of the plurality of cells; and
sending a report including the uplink timing advanced information to a network of the wireless communications system.

30. The method of claim 29, further comprising:
receiving a message including the uplink timing advanced information from the network, wherein the message is used for responding a preamble of the random access procedure initiated by the mobile device.

31. A method of enhancing positioning measurement for a mobile device in a wireless communications system, the method comprising:
determining or considering that a first type report associated with a positioning measurement has higher priority than a second type report which is not associated with the positioning measurement.

32. The method of claim 31, wherein determining that the first type report associated with the positioning measurement has higher priority than the second type report which is not associated with the positioning measurement comprises:
sending the first type report firstly to a network of the wireless communications system when an uplink grant is received from the network.

33. The method of claim 32, wherein a size of the uplink grant is capable of accommodating the first type report, and the first type report includes positioning measurement results of at least three of transmission points for performing transmission with the mobile device.

34. The method of claim 31, further comprising:
skipping sending the first type report to the network when the mobile device has not measured at least three positioning reference signal arrivals from at least three transmission points upon the expiration of the uplink grant; or
sending the first type report to the network with measured positioning reference signal arrivals when the mobile device has not measured at least three positioning reference signal arrivals from at least three transmission points upon the expiration of the uplink grant.
